(19) United States
(12) Patent Application Publication
(10) Pub. No.: US 2020/0406753 A1
(43) Pub. Date: Dec. 31, 2020

(54) DISPLAY CONTROL DEVICE, DISPLAY DEVICE, AND DISPLAY CONTROL METHOD

(71) Applicant: Mitsubishi Electric Corporation, Tokyo (JP)

(72) Inventor: Yayoi HAYASHI, Tokyo (JP)

(73) Assignee: Mitsubishi Electric Corporation, Tokyo (JP)

(21) Appl. No.: 16/976,880

(22) PCT Filed: Mar. 13, 2018
(86) PCT No.: PCT/JP2018/009675

§ 371 Date: Aug. 31, 2020

(51) Int. Cl. B60K 35/00; G09G 5/38; G08G 1/16; G01C 21/36

(52) U.S. Cl. CPC B60K 35/00; G09G 5/38; G08G 1/166; G01C 21/365; G09G 2380/10; B60K 2370/157; B60K 2370/193; B60K 2370/149; B60K 2370/167; B60K 2370/166; B60K 2370/1529

(57) ABSTRACT

A host vehicle information acquiring unit acquires host vehicle information indicating both a signal of a course change that a vehicle is to make, and a traveling direction in which the vehicle is to head because of the course change. An approaching object information acquiring unit acquires approaching object information indicating one or more approaching objects approaching the vehicle in a predetermined region in surroundings of the vehicle. An effective field of view determining unit determines an effective field of view of the driver of the vehicle. A target specifying unit specifies, out of the approaching objects approaching the vehicle, an approaching object approaching from a side opposite to the traveling direction in which the vehicle is to head on the basis of the host vehicle information and the approaching object information, and sets the specified approaching object as a target. When the vehicle makes the course change, a display information generating unit generates, on the basis of the host vehicle information, display information for displaying information about the target specified by the target specifying unit in the effective field of view of the driver that is determined by the effective field of view determining unit.

### TECHNICAL FIELD

The present disclosure relates to a display control device for and a display control method of controlling display of a head up display (referred to as an “HUD” hereinafter) , and a display device including an HUD.

### BACKGROUND ART

Because HUDs used for vehicles can display an image (also referred to as a “virtual image”) in the driver's line of sight, the driver's line-of-sight movements can be reduced. Recently, through the spread of augmented reality (AR) techniques of performing superimposed display of a virtual image on the real world, it is possible to perform superimposed display of a virtual image at the position of an actual target in the display area of an HUD to perform marking on the target. By performing marking using AR, information about driving support can be provided for the driver (for example, refer to Patent Literatures 1 and 2).

For example, a display device for vehicles according to Patent Literature 1 detects a traffic light or sign ahead of a vehicle, and, when the detected traffic light or sign is outside the driver's effective field of view, displays a virtual image that emphasizes the presence of the detected traffic light or sign, within the effective field of view of the driver in the display area of an HUD. The effective field of view is a range which is a part of a human being's visual field range, and in which a visual stimulus can be recognized.

Further, for example, a night visual range support device for vehicles according to Patent Literature 2 displays an image of an area ahead of a vehicle, the image being captured by an infrared camera, on a main display, and, when a pedestrian is present in the image displayed on the main display, a warning is displayed on an HUD. This night visual range support device for vehicles also displays a warning on the HUD even when a pedestrian who has disappeared from the image displayed on the main display is present in the driver's visual field range.

### CITATION LIST

### Patent Literature

Patent Literature 1: JP 2017-146737 A

Patent Literature 2: JP 2011-91549 A

### SUMMARY OF INVENTION

### Technical Problem

The target for virtual image display in the display device for vehicles according to Patent Literature 1 is only a stationary object, and is not a moving object such as another vehicle or a pedestrian. Therefore, the above-mentioned display device for vehicles cannot notify the driver of an object being outside the driver's effective field of view and approaching the host vehicle.

The night visual range support device for vehicles according to Patent Literature 2 estimates whether a pedestrian is present within the driver's visual field range on the basis of both a relative position of the host vehicle with respect to the pedestrian, and the traveling direction of the host vehicle. Therefore, when the host vehicle makes a right or left turn, a lane change, or the like, there is a very high possibility that a pedestrian approaching the host vehicle from a side opposite to the traveling direction in which the host vehicle is to head is not present both in the image displayed on the main display and in the driver's visual field range. In that case, the above-mentioned night visual range support device for vehicles cannot notify the driver of an object being outside the driver's visual field range and approaching the host vehicle.

Particularly at the time of a right or left turn or a lane change, there is a high possibility that the driver's effective field of view is focused on the direction in which the vehicle is to head, and thus the driver cannot easily notice the presence of an object being outside the driver's effective field of view and approaching the host vehicle. A problem with the conventional devices is that in such a situation, it is impossible to notify the driver of the presence of an object that is unlikely to be noticed by the driver.

The present disclosure is made in order to solve the above-mentioned problem, and it is therefore an object of the present disclosure to provide a technique for notifying the driver of an object being outside the driver's effective field of view and approaching the host vehicle.

### Solution to Problem

According to the present disclosure, there is provided a display control device for causing a head up display to display information which is to be provided for a driver of a vehicle, the display control device including: a host vehicle information acquiring unit for acquiring host vehicle information indicating both a signal of a course change that the vehicle is to make, and a traveling direction in which the vehicle is to head because of the course change; an approaching object information acquiring unit for acquiring approaching object information indicating one or more approaching objects approaching the vehicle in a predetermined region in surroundings of the vehicle; an effective field of view determining unit for determining an effective field of view of the driver of the vehicle; a target specifying unit for specifying, out of the approaching objects approaching the vehicle, an approaching object approaching from a side opposite to the traveling direction in which the vehicle is to head on the basis of the host vehicle information and the approaching object information, and for setting the specified approaching object as a target; and a display information generating unit for, when the vehicle makes the course change, generating, on the basis of the host vehicle information, display information for displaying information about the target specified by the target specifying unit in the effective field of view of the driver, the effective field of view being determined by the effective field of view determining unit.

### Advantageous Effects of Invention

According to the present disclosure, because when the vehicle makes a course change, information about a target approaching from the side opposite to the traveling direction in which the vehicle is to head is caused to be displayed in the effective field of view of the driver, the driver can be notified of the presence of the target that is unlikely to be noticed by the driver.

### BRIEF DESCRIPTION OF DRAWINGS

FIG. 1 is a block diagram showing an example of the configuration of a display device according to Embodiment 1;

FIG. 2 is a table showing an example of pieces of effective field of view information in Embodiment 1 in each of which a correspondence among an internal factor, an external factor, and an effective field of view is defined;

FIG. 3 is a bird's-eye view showing an example of a situation in which a host vehicle makes a right-hand turn after signaling a course change to the right in Embodiment 1;

FIG. 4 is a view showing a front view that is in sight of the driver of the host vehicle in the situation shown in FIG. 3;

FIG. 5 is a flowchart showing an example of the operation of the display device according to Embodiment 1;

FIG. 6 is a flowchart showing an example of the operation of an effective field of view determining unit in step ST3 of FIG. 5;

FIG. 7 is a flowchart showing an example of the operation of a target specifying unit in step ST4 of FIG. 5;

FIG. 8 is a flowchart showing an example of the operation of a display information generating unit in step ST5 of FIG. 5;

FIG. 9 is a view showing an example of a positional relationship between the driver and the effective field of view in the situation shown in FIG. 3;

FIG. 10 is a view showing an example of an object in Embodiment 1;

FIG. 11 is a view showing an example of display information generated in the situation shown in FIG. 3;

FIG. 12 is a view showing a state in which display to provide a notification of the presence of a target is superimposed on a front view that is in sight of the driver of the host vehicle in the situation shown in FIG. 3;

FIG. 13 is a block diagram showing an example of the configuration of a display device according to Embodiment 2;

FIG. 14 is a bird's-eye view showing an example of a situation in which a host vehicle makes a lane change to a right-hand lane after signaling a course change to the right in Embodiment 2;

FIG. 15 is a view showing a front view that is in sight of the driver of the host vehicle in the situation shown in FIG. 14;

FIG. 16 is a flowchart showing an example of the operation of a display information generating unit of Embodiment 2 in step ST5 of FIG. 5;

FIG. 17 is a view showing an example of objects in Embodiment 2;

FIG. 18 is a view showing an example of display information generated in the situation shown in FIG. 14;

FIG. 19 is a view showing a state in which display to provide a notification of the presence of a target and display coinciding with the actual target are superimposed on a front view that is in sight of the driver of the host vehicle in the situation shown in FIG. 14;

FIG. 20 is a block diagram showing an example of the configuration of a display device according to Embodiment 3;

FIG. 21 is a bird's-eye view showing an example of a situation in which a host vehicle makes a left-hand turn after signaling a course change to the left in Embodiment 3;

FIG. 22 is a view showing a front view that is in sight of the driver of the host vehicle in the situation shown in FIG. 21;

FIG. 23 is a flowchart showing an example of the operation of the display device according to Embodiment3;

FIG. 24 is a view showing an example of objects in Embodiment 3;

FIG. 25 is a view showing an example of display information generated in the situation shown in FIG. 21;

FIG. 26 is a view showing a state in which display to provide a notification of the presence of a target is superimposed on a front view that is in sight of the driver of the host vehicle in the situation shown in FIG. 21;

FIG. 27 is a diagram showing an example of the hardware configuration of the display device according to each of the embodiments; and

FIG. 28 is a diagram showing another example of the hardware configuration of the display device according to each of the embodiments.

### DESCRIPTION OF EMBODIMENTS

Hereinafter, in order to explain the present disclosure in greater detail, embodiments of the present disclosure will be described with reference to the accompanying drawings.

### Embodiment 1

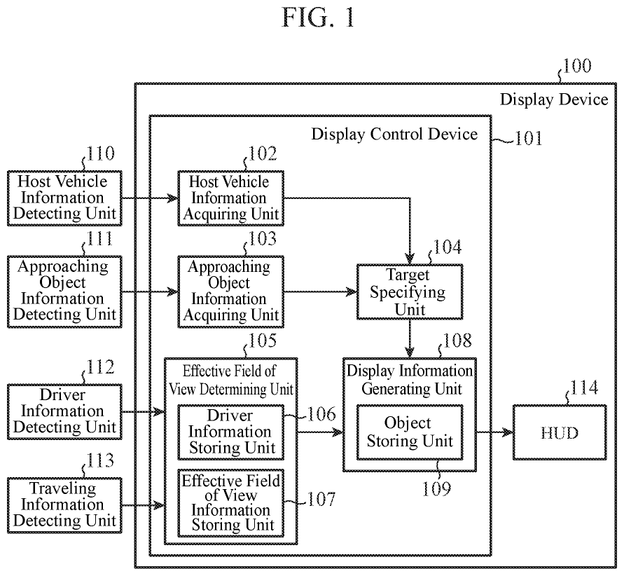

FIG. 1 is a block diagram showing an example of the configuration of a display device 100 according to Embodiment 1. When there is a very high possibility that the effective field of view of the driver of a vehicle is focused on a traveling direction in which the vehicle is to head, such as when the vehicle makes a right- or left-hand turn or a lane change, in order to cause the driver to notice the presence of a target that is approaching from a side opposite to the above-mentioned traveling direction and that the driver is unlikely to recognize, the display device 100 performs display to emphasize the presence of the above-mentioned target in the effective field of view of the driver.

The display device 100 includes a display control device 101 and an HUD 114. The display control device 101 includes a host vehicle information acquiring unit 102, an approaching object information acquiring unit 103, a target specifying unit 104, an effective field of view determining unit 105, and a display information generating unit 108. The effective field of view determining unit 105 includes a driver information storing unit 106 and an effective field of view information storing unit 107. The display information generating unit 108 includes an object storing unit 109. Further, a host vehicle information detecting unit 110, an approaching object information detecting unit 111, a driver information detecting unit 112, and a traveling information detecting unit 113 are connected to the display device 100.

The host vehicle information detecting unit 110, the approaching object information detecting unit 111, the driver information detecting unit 112, the traveling information detecting unit 113, and the HUD 114 are mounted in the vehicle. On the other hand, the display control device 101 may be mounted in the vehicle, or may be configured as a server device outside the vehicle and a configuration may be provided in which information is transmitted and received via wireless communications between the server device and the host vehicle information detecting unit 110 and so on in the vehicle.

The host vehicle information detecting unit 110 is constituted by a direction indicator, a steering angle sensor for detecting the steering angle, a car navigation device for providing guidance about a scheduled traveling route, or the like. More specifically, the host vehicle information detecting unit 110 should just detect host vehicle information indicating both a signal of a course change that the host vehicle is to make, and a traveling direction in which the vehicle is to head because of this course change. The signal of a course change is a signal of a right-hand turn, a left-hand turn, a lane change to a right-hand lane, or a lane change to a left-hand lane of the host vehicle, and indicates, for example, a timing at which the direction indicator is operated by the driver. The traveling direction indicates whether the host vehicle is to make a right-hand turn, a left-hand turn, a lane change to a right-hand lane, or a lane change to a left-hand lane, and indicates, for example, the scheduled traveling route of the car navigation device.

The host vehicle information acquiring unit 102 acquires the host vehicle information from the host vehicle information detecting unit 110. The host vehicle information indicates both a signal of a course change that the host vehicle is to make, and the traveling direction in which the vehicle is to head because of this course change, as mentioned above, and the host vehicle information is information indicating the lighting state of the direction indicator, information indicating the steering angle detected by the steering angle sensor, information indicating the scheduled traveling route that the car navigation device is providing as guidance, or the like. The host vehicle information acquiring unit 102 determines whether there is a signal of a course change on the basis of the host vehicle information, and, when a signal of a course change is provided, outputs information indicating the traveling direction in which the vehicle is to head because of this course change to the target specifying unit 104.

The approaching object information detecting unit 111 is constituted by an externally mounted camera that captures an image of a predetermined region in the surroundings of the host vehicle, or the like. The predetermined region is, for example, a circular region having a diameter of 50 m ahead of the host vehicle. The approaching object information detecting unit 111 outputs the captured image or the like, as approaching object detection information, to the approaching object information acquiring unit 103.

The approaching object information acquiring unit 103 acquires the approaching object detection information from the approaching object information detecting unit 111. The approaching object information acquiring unit 103 detects an approaching object approaching the host vehicle in the above-mentioned predetermined region from the captured image that is the approaching object detection information. Further, the approaching object information acquiring unit 103 specifies the position and the type of each detected approaching object, generates approaching object information indicating the position and the type of each approaching object, and outputs the approaching object information to the target specifying unit 104. The types of approaching objects include vehicle, bicycle, and pedestrian. For example, the approaching object information acquiring unit 103 estimates the moving directions of objects, such as vehicles, bicycles, and pedestrians, from multiple captured images captured in time sequence, and thereby determines whether or not each object is approaching the host vehicle.

The target specifying unit 104 acquires the information indicating the traveling direction from the host vehicle information acquiring unit 102, and also acquires the approaching object information from the approaching object information acquiring unit 103. The target specifying unit 104 specifies an approaching object approaching from the side opposite to the traveling direction in which the host vehicle is to head, out of the approaching objects approaching the host vehicle, on the basis of the information indicating the traveling direction and the approaching object information, and sets the specified approaching object as a target. The target specifying unit 104 generates target information indicating the position and the type of the target, and outputs the target information and the information indicating the traveling direction to the display information generating unit 108.

By the way, a human being's visual field range has an effective field of view that is a range in which a visual stimulus can be recognized. Although it is said that the effective fields of view of drivers range from 4 degrees to 20 degrees, the range changes in accordance with the drivers' internal and external factors. An internal factor is a driver's driving characteristic including the driver's age and driving skill level. An external factor is a traveling environment of a vehicle including a vehicle speed, a congestion level, and the number of lanes.

The driver information detecting unit 112 is constituted by an internally mounted camera that captures an image for specifying the position of the driver in the vehicle and for identifying the driver, or the like. The driver information detecting unit 112 outputs the captured image or the like, as driver information, to the effective field of view determining unit 105.

The traveling information detecting unit 113 is constituted by an acceleration sensor or the like that detects the vehicle speed of the host vehicle, and an externally mounted camera, a millimeter wave radar, a map information database, or the like that detects the traveling location of the host vehicle, the congestion level, and the number of lanes. The traveling information detecting unit 113 outputs the vehicle speed and so on, as traveling information, to the effective field of view determining unit 105. The externally mounted camera of the traveling information detecting unit 113 may also be used as the externally mounted camera of the approaching object information detecting unit 111.

Driver information in which a correspondence between a face image of the driver and driving characteristic information is defined is registered in the driver information storing unit 106 in advance. The driving characteristic information includes age and a driving skill level that are internal factors causing the effective field of view of the driver to change.

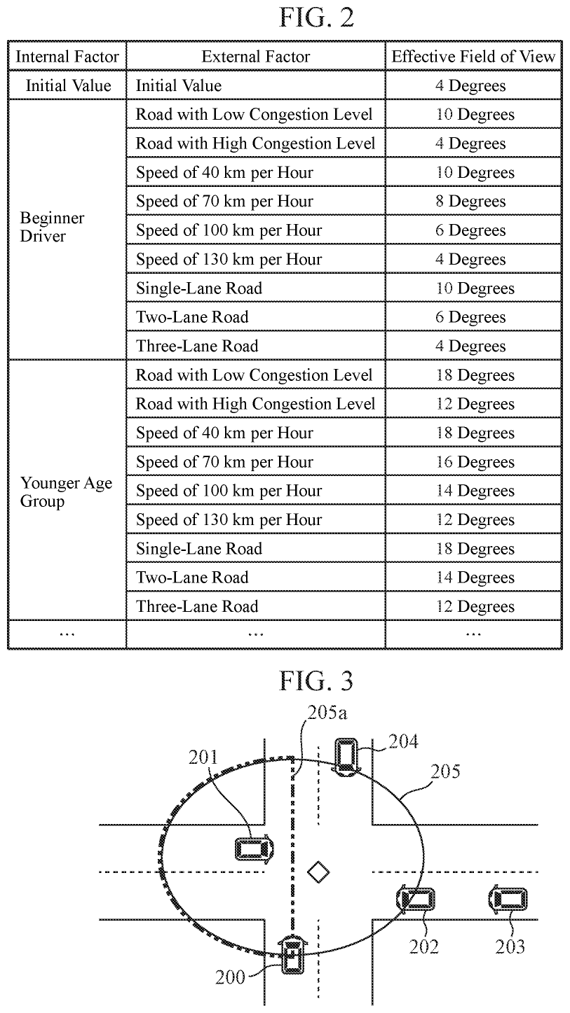

Pieces of effective field of view information in each of which a correspondence among an internal factor, an external factor, and an effective field of view is defined are registered in the effective field of view information storing unit 107 in advance. FIG. 2 is a table showing an example of the pieces of effective field of view information in Embodiment 1 in each of which a correspondence among an internal factor, an external factor, and an effective field of view is defined.

The effective field of view determining unit 105 acquires the driver information from the driver information detecting unit 112, and also acquires the traveling information from the traveling information detecting unit 113. The effective field of view determining unit 105 determines the position of the head of the driver from the captured image that is the driver information, and outputs the position, as driver position information, to the display information generating unit 108.

Further, the effective field of view determining unit 105 detects the face of the driver from the captured image that is the driver information, and identifies the driver by comparing the detected face of the driver with the pieces of driver's face information that are registered in the driver information storing unit 106 in advance. Then, the effective field of view determining unit 105 acquires the driving characteristic information associated with the identified driver from the driver information storing unit 106.

In addition, the effective field of view determining unit 105 compares the driver characteristic information acquired from the driver information storing unit 106 and the traveling information acquired from the traveling information detecting unit 113, respectively, with the internal factors and the external factors that are registered in the effective field of view information storing unit 107 in advance, to determine the effective field of view of the driver. The effective field of view determining unit 105 outputs information indicating the determined effective field of view to the display information generating unit 108.

Here, an example of a method of specifying a traveling environment, the method being used by the effective field of view determining unit 105, is described. As to a road's congestion level that is one traveling environment, for example, when the number of objects, such as vehicles, bicycles, and pedestrians, which are seen in an image acquired by capturing an area in the surroundings of the vehicle is less than a predetermined threshold, the effective field of view determining unit 105 specifies that the road has a low congestion level, whereas when the number is equal to or greater than the threshold, the effective field of view determining unit 105 specifies that the road has a high congestion level. In the example of FIG. 2, when a beginner driver is driving along a road having a high congestion level, because the internal factor is a beginner driver and the external factor is a road having a high congestion level, the effective field of view is 4 degrees. Further, when a driver in a younger age group is driving along a single-lane road, because the internal factor is a younger age group and the external factor is a single-lane road, the effective field of view is 18 degrees. Further, the initial value of the effective field of view is set to 4 degrees that is the narrowest of the ranges regarded as the effective field of view of a driver.

Objects to be displayed by the HUD 114 are registered in the object storing unit 109 in advance. The objects include an arrow indicating the position of a target, a text or icon indicating the type of a target, and a marker enclosing a target.

The display information generating unit 108 acquires the target information and the information indicating the traveling direction from the target specifying unit 104, and also acquires the driver position information and the information indicating the effective field of view from the effective field of view determining unit 105. The display information generating unit 108 specifies the types of objects to be displayed by the HUD 114, the number of objects to be displayed, and so on out of the objects that are registered in the object storing unit 109 in advance, on the basis of the target information and the information indicating the traveling direction. Further, the display information generating unit 108 determines the display positions of the objects in the display area of the HUD 114 on the basis of the driver position information and the information indicating the effective field of view. Information indicating the display area of the HUD 114 is provided for the display information generating unit 108 in advance. Then, the display information generating unit 108 generates display information in which the objects are arranged at the display positions, and outputs the display information to the HUD 114. A method of generating the display information will be mentioned later.

The HUD 114 acquires the display information from the display information generating unit 108 and projects the display information onto the front window of the vehicle or a combiner.

Next, an example of the operation of the display device 100 will be explained.

Hereinafter, the operation of the display device 100 will be explained using, as an example, a case in which the host vehicle makes a right-hand turn at an intersection. FIG. 3 is a bird's-eye view showing an example of a situation in which the host vehicle 200 makes a right-hand turn after signaling a course change to the right in Embodiment 1. In the example shown in FIG. 3, a different vehicle 201 is present on a left-hand side of the road where the host vehicle 200 is to make a right-hand turn, different vehicles 202 and 203 are present on a right-hand side of the road, and a different vehicle 204 is present in an opposite lane of the road on which the host vehicle 200 has traveled straight ahead.

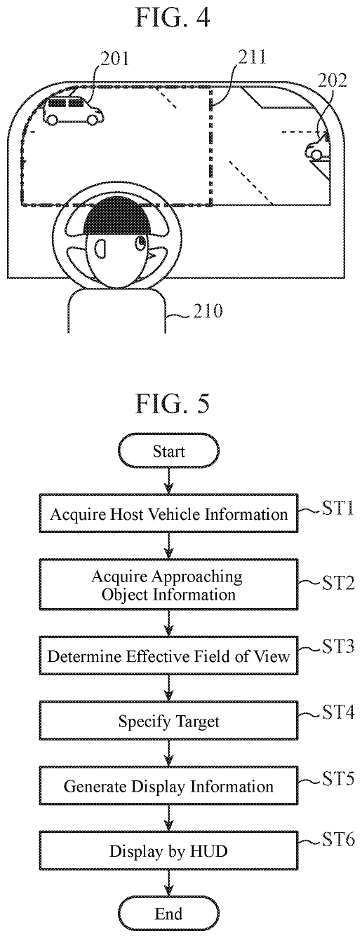

FIG. 4 is a diagram showing a front view that is in sight of the driver 210 of the host vehicle 200 in the situation shown in FIG. 3. In the example shown in FIG. 4, the driver 210's side portion of the front window of the host vehicle 200 is an HUD display area 211 that is the display area of the HUD 114. The driver 210 can view the different vehicles 201 and 202 through the front window.

FIG. 5 is a flowchart showing an example of the operation of the display device 100 according to Embodiment 1. The display device 100 repeats the operation shown in the flowchart of FIG. 5.

Instep ST1, the host vehicle information acquiring unit 102 acquires the host vehicle information including a signal indicating that the host vehicle 200 is to make a right-hand turn from the host vehicle information detecting unit 110. When determining that the host vehicle 200 is to make a right-hand turn on the basis of the host vehicle information, the host vehicle information acquiring unit 102 outputs information about the traveling direction, this information indicating that the host vehicle 200 is to make a right-hand turn, to the target specifying unit 104.

In step ST2, the approaching object information acquiring unit 103 acquires the approaching object detection information from the approaching object information detecting unit 111, and detects the different vehicles 201, 202, and 204 approaching the host vehicle 200 in a predetermined approaching object detection region 205 on the basis of the approaching object detection information. Then, the approaching object information acquiring unit 103 outputs the approaching object information indicating that the approaching objects approaching the host vehicle 200 in the approaching object detection region 205 are the different vehicle 201 on the left-hand side of the host vehicle 200, and the different vehicles 202 and 204 on the right-hand side of the host vehicle 200 to the target specifying unit 104.

In step ST3, the effective field of view determining unit 105 acquires the driver information from the driver information detecting unit 112, and also acquires the traveling information from the traveling information detecting unit 113. The effective field of view determining unit 105 determines the position and the effective field of view of the driver 210 on the basis of the driver information and the traveling information, and outputs the driver position information and information indicating the effective field of view to the display information generating unit 108.

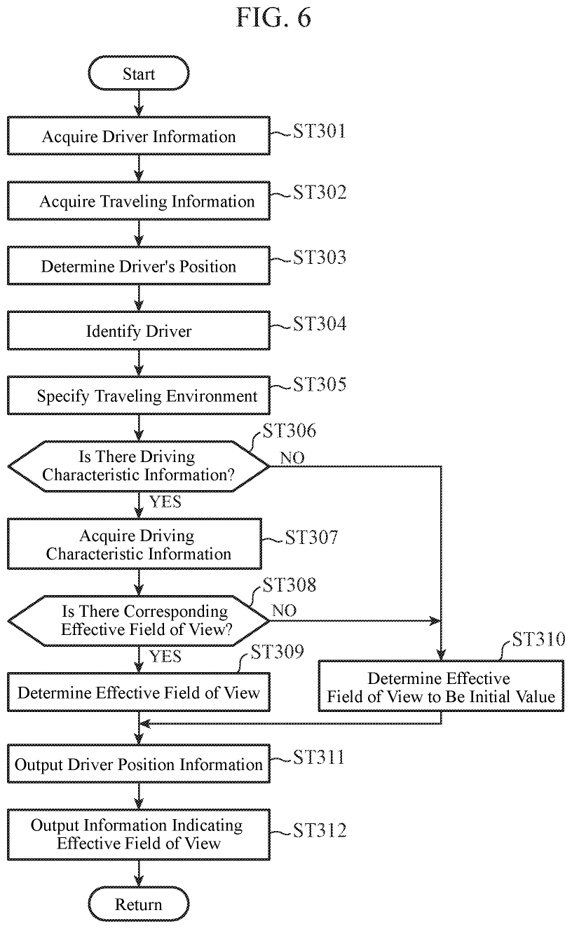

FIG. 6 is a flowchart showing an example of the operation of the effective field of view determining unit 105 in step ST3 of FIG. 5.

In step ST301, the effective field of view determining unit 105 acquires the driver information from the driver information detecting unit 112. In step ST302, the effective field of view determining unit 105 acquires the traveling information from the traveling information detecting unit 113.

In step ST303, the effective field of view determining unit 105 determines the position of the head of the driver 210 on the basis of the driver information acquired in step ST301. In step ST304, the effective field of view determining unit 105 identifies the driver 210 on the basis of the driver information acquired in step ST301 and the face images registered in the driver information storing unit 106.

In step ST305, the effective field of view determining unit 105 specifies the traveling environment of the host vehicle 200 on the basis of the traveling information acquired in step

ST302. In the example of FIG. 3, it is assumed that it is specified as the traveling environment of the host vehicle 200 that the road has a low congestion level.

In step ST306, the effective field of view determining unit 105 checks whether or not the driving characteristic information associated with the driver 210 identified in step ST304 is in the driver information storing unit 106. When the driving characteristic information is in the driver information storing unit 106 (“YES” in step ST306), the effective field of view determining unit 105 proceeds to step ST307. In contrast, when, in step ST304, no face image corresponding to the driver 210 is in the driver information storing unit 106 and thus no individual can be identified or when there is a corresponding face image, but no driving characteristic information is associated with the face image (“NO” in step ST306), the effective field of view determining unit 105 proceeds to step ST310. In step ST307, the effective field of view determining unit 105 acquires the driving characteristic information associated with the driver 210 from the driver information storing unit 106. It is assumed that the driving characteristic information associated with the driver 210 in this example indicates that the driver is a beginner.

In step ST308, the effective field of view determining unit 105 checks whether the effective field of view information having the internal and external factors corresponding to the traveling environment specified in step ST305 and the driving characteristic information acquired in step ST306 is in the effective field of view information storing unit 107. When the effective field of view information is in the effective field of view information storing unit 107 (“YES” in step ST308), the effective field of view determining unit 105 proceeds to step ST309, whereas when the effective field of view information is not in (“NO” in step ST308), the effective field of view determining unit 105 proceeds to step ST310.

In step ST309, the effective field of view determining unit 105 determines that the effective field of view included in the effective field of view information having the internal and external factors corresponding to the traveling environment and the driving characteristic information is the effective field of view of the driver 210. In contrast, in step ST310, the effective field of view determining unit 105 determines that the effective field of view that is registered as the initial value in the effective field of view information storing unit 107 is the effective field of view of the driver 210. In this example, because the traveling environment, i.e., the external factor is a road having a low congestion level, and the driving characteristic, i.e., the internal factor is a beginner driver, the effective field of view of the driver 210 is 10 degrees.

In step ST311, the effective field of view determining unit 105 outputs, as the driver position information, the position of the head of the driver 210, the position being determined in step ST303, to the display information generating unit 108. In step ST312, the effective field of view determining unit 105 outputs information indicating the effective field of view of the driver 210 which is determined in step ST309 or ST310 to the display information generating unit 108.

In step ST4, the target specifying unit 104 acquires the information indicating the traveling direction of the host vehicle 200 from the host vehicle information acquiring unit 102, and also acquires the approaching object information about the different vehicles 201, 202, and 204 from the approaching object information acquiring unit 103. The target specifying unit 104 specifies a target on the basis of these pieces of information, and outputs target information and the information indicating the traveling direction to the display information generating unit 108.

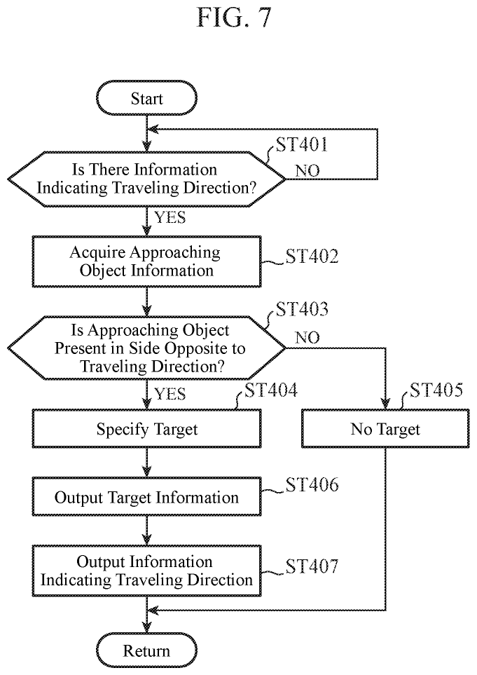

FIG. 7 is a flowchart showing an example of the operation of the target specifying unit 104 in step ST4 of FIG. 5.

In step ST401, the target specifying unit 104 checks whether the target specifying unit 104 has acquired the information about the traveling direction, the information indicating that the host vehicle 200 is to make a right-hand turn, from the host vehicle information acquiring unit 102.

When having acquired the information about the traveling direction (“YES” in step ST401), the target specifying unit 104 proceeds to step ST402, whereas when not having acquired the information about the traveling direction (“NO” in step ST401), the target specifying unit 104 repeats step ST401.

In step ST402, the target specifying unit 104 acquires the approaching object information about the different vehicles 201, 202, and 204 from the approaching object information acquiring unit 103.

In step ST403, the target specifying unit 104 checks whether an approaching object is present in the side opposite to the traveling direction of the host vehicle 200 on the basis of the information about the traveling direction acquired in step ST401 and the approaching object information acquired in step ST402. When an approaching object is present in the side opposite to the traveling direction (“YES” in step ST403), the target specifying unit 104 proceeds to step ST404, whereas when no approaching object is present in the side (“NO” in step ST403), the target specifying unit 104 proceeds to step ST405. In step ST404, the target specifying unit 104 specifies that the approaching object present in the side opposite to the traveling direction is a target. In contrast, in step ST405, the target specifying unit 104 determines that no target is present because no approaching object is present in the side opposite to the traveling direction. In the example of FIG. 2, the different vehicle 201 that is an approaching object is present in the side 205a opposite to the traveling direction in which the host vehicle 200 is to head, with respect to the position of this host vehicle 200 that is about to enter the intersection. Therefore, the different vehicle 201 is specified as a target. In contrast, because the different vehicles 202 and 204 that are approaching objects are present in the traveling direction in which the host vehicle 200 is to head, with respect to the position of this host vehicle 200, the different vehicles 202 and 204 are not targets.

In step ST406, the target specifying unit 104 outputs target information indicating the different vehicle 201 that is a target specified in step ST404 to the display information generating unit 108. In step ST407, the target specifying unit 104 outputs the information indicating the traveling direction acquired in step ST401 to the display information generating unit 108.

In step ST5, the display information generating unit 108 acquires the information indicating the traveling direction of the host vehicle 200 and the target information from the target specifying unit 104, and also acquires the driver position information about the driver 210 and the information indicating the effective field of view from the effective field of view determining unit 105. The display information generating unit 108 generates display information on the basis of these pieces of information, and outputs the display information to the HUD 114.

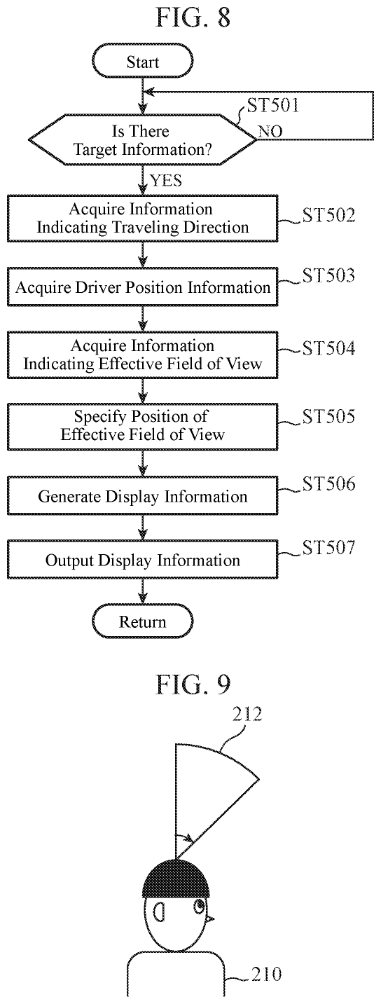

FIG. 8 is a flowchart showing an example of the operation of the display information generating unit 108 in step ST5 of FIG. 5.

In step ST501, the display information generating unit 108 checks whether the display information generating unit 108 has acquired the target information from the target specifying unit 104. When having acquired the target information (“YES” in step ST501), the display information generating unit 108 proceeds to step ST502, whereas when not having acquired the target information (“NO” in step ST501), the display information generating unit 108 repeats step ST501.

In step ST502, the display information generating unit 108 acquires the information about the traveling direction, the information indicating that the host vehicle 200 is to make a right-hand turn, from the host vehicle information acquiring unit 102. In step ST503, the display information generating unit 108 acquires the driver position information indicating the position of the head of the driver 210 from the effective field of view determining unit 105. In step ST504, the display information generating unit 108 acquires the information indicating the effective field of view of the driver 210 from the effective field of view determining unit 105.

In step ST505, the display information generating unit 108 specifies the effective field of view of the driver 210 in the host vehicle 200 on the basis of the information acquired in step ST502 and indicating the traveling direction, the driver position information acquired in step ST503, and the information acquired in step ST504 and indicating the effective field of view. Here, an example of the positional relationship between the driver 210 and the effective field of view 212 in the situation shown in FIG. 3 is shown in FIG. 9. Because the traveling direction of the host vehicle 200 is a right-hand direction, and the effective field of view of the driver 210 is 10 degrees, the display information generating unit 108 specifies, as the effective field of view 212, a region of 10 degrees on a right-hand side in front of this driver 210 with respect to the position of the head of the driver 210.

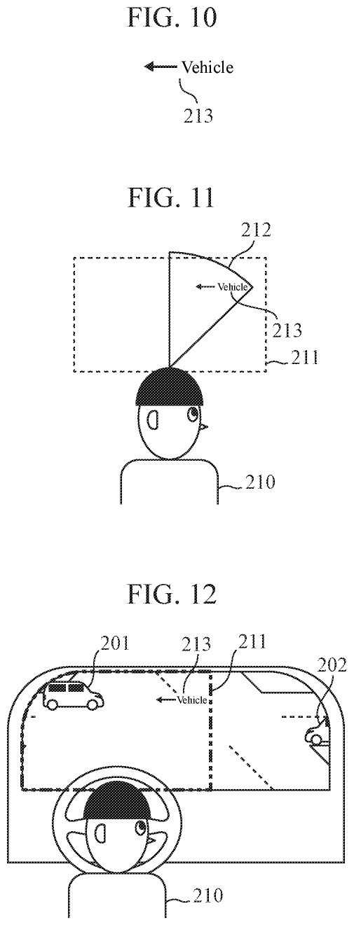

In step ST506, the display information generating unit 108 generates display information on the basis of the target information acquired in step ST501, the information acquired in step ST502 and indicating the traveling direction, the effective field of view 212 of the driver 210 which is specified in step ST505, and the predetermined display area of the HUD 114. Here, an example of an object 213 in Embodiment 1 is shown in FIG. 10. FIG. 11 is a diagram showing an example of the display information generated in the situation shown in FIG. 3. The display information generating unit 108 selects an object that is a left-directed arrow and an object that is a text “vehicle” for expressing that the different vehicle 201 is approaching from a left-hand side opposite to the traveling direction of the host vehicle 200, out of the objects registered in the object storing unit 109, and combines both the objects to generate an object 213. This object 213 is display to notify the driver 210 of the presence of the different vehicle 201, and thus it is preferable that the object 213 has a prominent color. Then, the display information generating unit 108 determines the position of the object 213 in the effective field of view 212 of the driver 210 and in the HUD display area 211, and generates display information including the content and the position of the object 213, as shown in FIG. 11. In the example of FIG. 11, the position of the object 213 is determined in such a way that the arrow of the object 213 is directed toward the actual different vehicle 201 that is viewed through the windshield of the host vehicle 200.

Although in the example of FIG. 11 the object that is the text “vehicle” is selected because the type of the target is vehicle, an object that is a text “pedestrian” is selected when the type of the target is pedestrian.

In step ST507, the display information generating unit 108 outputs the display information generated in step ST506 to the HUD 114.

In step ST6, the HUD 114 acquires the display information from the display information generating unit 108, and displays the display information in the HUD display area 211. Here, a state in which the object 213 to provide a notification of the presence of the different vehicle 201 is superimposed on a front view that is in sight of the driver 210 of the host vehicle 200 in the situation shown in FIG. 3 is shown in FIG. 12. Because there is a high possibility that the driver 210 views a right-hand side toward which the vehicle is to head, there is a high possibility that the driver 210 does not notice the different vehicle 201 approaching from a left-hand side. In this situation, because the object 213 is displayed in the effective field of view 212 of the driver 210, the driver 210 can surely recognize the object 213 and thereby recognize the presence of the different vehicle 201.

As mentioned above, the display device 100 according to Embodiment 1 includes the HUD 114 and the display control device 101. The display control device 101 includes the host vehicle information acquiring unit 102, the approaching object information acquiring unit 103, the effective field of view determining unit 105, the target specifying unit 104, and the display information generating unit 108. The host vehicle information acquiring unit 102 acquires host vehicle information indicating both a signal of a course change which the vehicle is to make, and a traveling direction in which the vehicle is to head because of the course change. The approaching object information acquiring unit 103 acquires approaching object information indicating one or more approaching objects approaching the vehicle in a predetermined region in the surroundings of the vehicle. The effective field of view determining unit 105 determines the effective field of view of the driver of the vehicle. The target specifying unit 104 specifies, out of the approaching objects approaching the vehicle, an approaching object approaching from a side opposite to the traveling direction in which the vehicle is to head on the basis of the host vehicle information and the approaching object information, and sets the specified approaching object as a target. The display information generating unit 108 generates, when the vehicle makes the course change, display information for displaying information about the target specified by the target specifying unit 104 in the effective field of view of the driver determined by the effective field of view determining unit 105, on the basis of the host vehicle information. With this configuration, the display device 100 can notify the driver of the presence of the target that is unlikely to be noticed by the driver.

Further, the effective field of view determining unit 105 of Embodiment 1 changes the effective field of view of the driver on the basis of at least one of the driving characteristic of the driver and the traveling environment of the vehicle. With this configuration, the display device 100 can determine the current effective field of view of the driver more correctly on the basis of at least one of the internal and external factors that cause the effective field of view of the driver to change. Further, because the display device 100 can display information about the target in a more correct effective field of view, the display device 100 can more surely notify the driver of the target.

### Embodiment 2

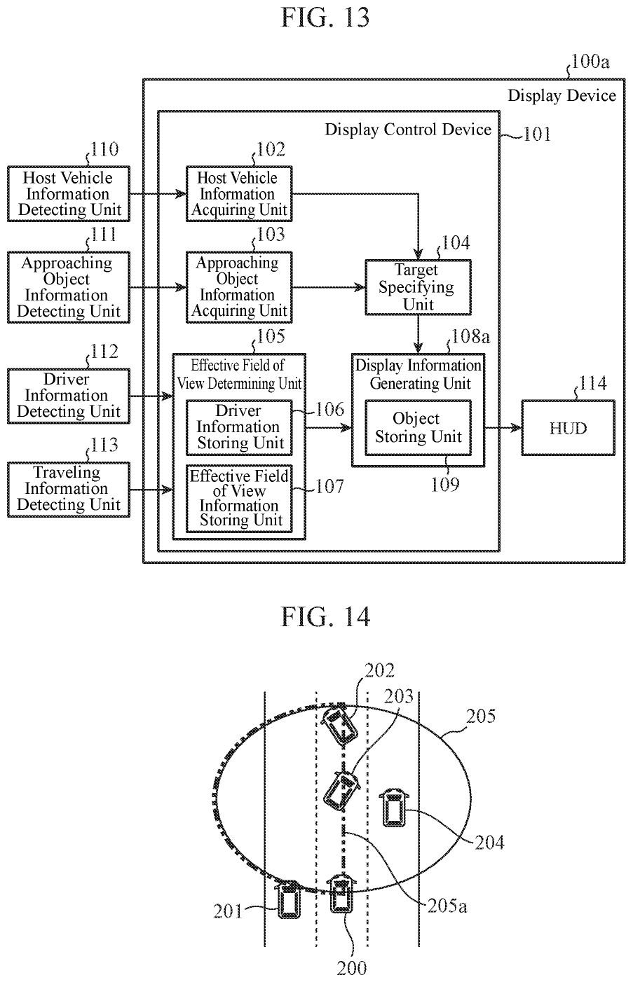

FIG. 13 is a block diagram showing an example of the configuration of a display device 100a according to Embodiment 2. The display device 100a according to Embodiment 2 has a configuration in which the display information generating unit 108 of the display device 100 of Embodiment 1 shown in FIG. 1 is changed to a display information generating unit 108a. In FIG. 13, components which are the same as or equivalent to those shown in FIG. 1 are denoted by the same reference signs, and an explanation of the components will be omitted hereinafter.

The display information generating unit 108a of Embodiment 2 changes a display mode of information about a target approaching from a side opposite to a traveling direction in which a host vehicle is to head, in accordance with whether the target is present inside or outside a display area of an HUD 114.

Next, an example of the operation of the display device 100a will be explained.

Hereinafter, the operation of the display device 100a will be explained using, as an example, a case in which the host vehicle makes a lane change to a right-hand lane. FIG. 14 is a bird's-eye view showing an example of a situation in which the host vehicle 200 makes a lane change to a right-hand lane after signaling a course change to the right in Embodiment 2. In the example of FIG. 14, a different vehicle 201 is present on another lane on a left-hand side of the lane on which the host vehicle 200 has traveled, different vehicles 202 and 203 are present in front on the lane on which the host vehicle 200 has traveled straight ahead, and a different vehicle 204 is present on a right-hand lane to which the host vehicle 200 is to make a lane change. The different vehicles 201 and 204 are traveling straight ahead, the different vehicle 202 is about to make a lane change to a left-hand lane, and the different vehicle 203 is about to make a lane change to a right-hand lane.

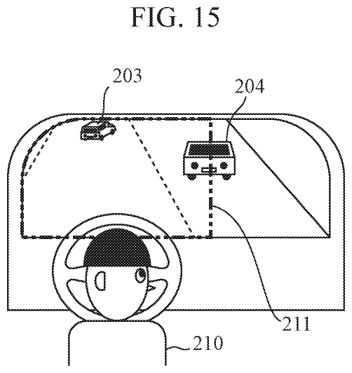

FIG. 15 is a view showing a front view that is in sight of the driver 210 of the host vehicle 200 in the situation shown in FIG. 14. In the example shown in FIG. 15, the driver 210's side portion of the front window of the host vehicle 200 is an HUD display area 211 that is the display area of the HUD 114. The driver 210 can view the different vehicles 203 and 204 through the front window.

The display device 100a of Embodiment 2 repeats the operation shown in the flowchart of FIG. 5. Hereinafter, an explanation will be made focusing on the difference between the operation of the display device 100 of Embodiment 1 and that of the display device 100a of Embodiment 2.

In step ST2, an approaching object information acquiring unit 103 detects the different vehicles 203 and 204 approaching the host vehicle 200 in a predetermined approaching object detection region 205 on the basis of approaching object detection information acquired from an approaching object information detecting unit 111. Then, the approaching object information acquiring unit 103 outputs approaching object information indicating that the approaching objects approaching the host vehicle 200 in the approaching object detection region 205 are the different vehicle 203 traveling toward a left-hand side from an area ahead of the host vehicle 200, and the different vehicle 204 present on a right-hand side of the host vehicle 200 to a target specifying unit 104.

In step ST3, an effective field of view determining unit 105 determines the position and the effective field of view of the driver 210 on the basis of driver information acquired from a driver information detecting unit 112 and traveling information acquired from a traveling information detecting unit 113, and outputs driver position information and information indicating the effective field of view to the display information generating unit 108a. In the example of FIG. 14, the effective field of view determining unit 105 specifies that the driver 210 in a younger age group is driving along a three-lane road, and determines that the effective field of view is 12 degrees by referring to effective field of view information registered in an effective field of view information storing unit 107. The effective field of view determining unit 105 outputs information indicating the determined effective field of view of the driver 210 to the display information generating unit 108a.

In step ST4, the target specifying unit 104 specifies that the different vehicle 203 present in the side 205a opposite to the traveling direction of the host vehicle 200 is a target on the basis of information acquired from a host vehicle information acquiring unit 102 and indicating the traveling direction of the host vehicle 200, and the approaching object information about the different vehicles 203 and 204 acquired from the approaching object information acquiring unit 103. The target specifying unit 104 outputs target information indicating the specified different vehicle 203 to the display information generating unit 108a.

In step ST5, the display information generating unit 108a generates display information on the basis of the information indicating the traveling direction and the target information which are acquired from the target specifying unit 104, and the driver position information and the information indicating the effective field of view which are acquired from the effective field of view determining unit 105, and outputs the display information to the HUD 114.

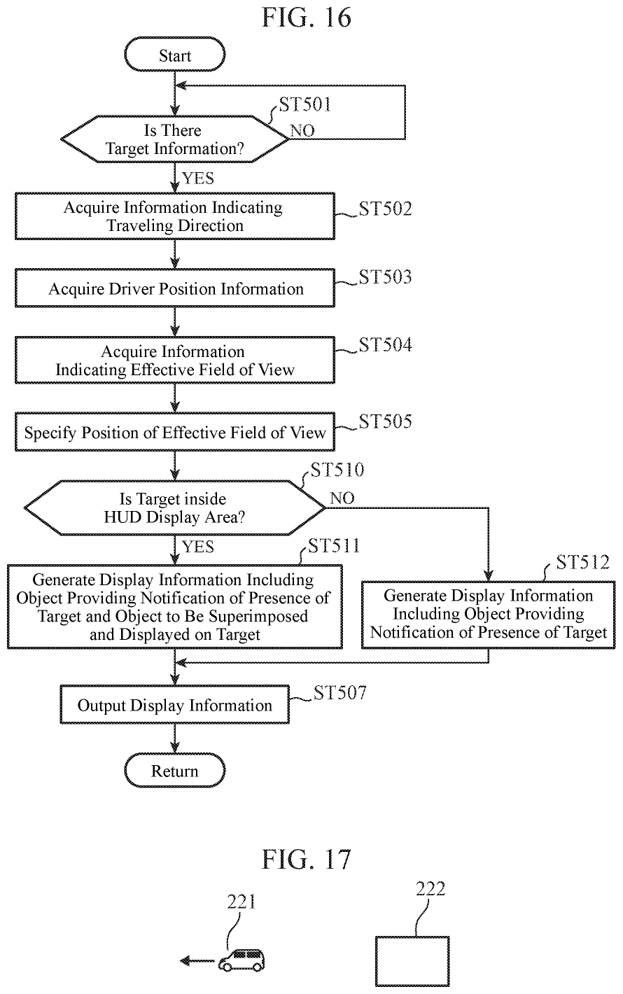

FIG. 16 is a flowchart showing an example of the operation of the display information generating unit 108a of Embodiment 2 in step ST5 of FIG. 5. Steps ST501 to ST505, and ST507 of FIG. 16 show the same processes as those of steps ST501 to ST505, and ST507 of FIG. 8.

In step ST510, the display information generating unit 108a checks whether or not the target is inside the display area of the HUD 114 on the basis of the target information acquired in step ST501, the effective field of view of the driver 210 which is specified in step ST505, and the predetermined display area of the HUD 114. When the target is inside the display area of the HUD 114 (“YES” in step ST510), the display information generating unit 108a proceeds to step ST511, whereas when the target is outside the display area of the HUD 114 (“NO” in step ST510), the display information generating unit 108a proceeds to step ST512.

When the target is inside the effective field of view, there is a high possibility that the driver 210 has noticed the target. Therefore, the display information generating unit 108a does not perform display to notify the driver 210 of the presence of the target. Similarly, also in Embodiment 1 and in below-mentioned Embodiment 3, the display information generating unit 108 does not have to perform display to notify the driver 210 of the presence of the target in the effective field of view.

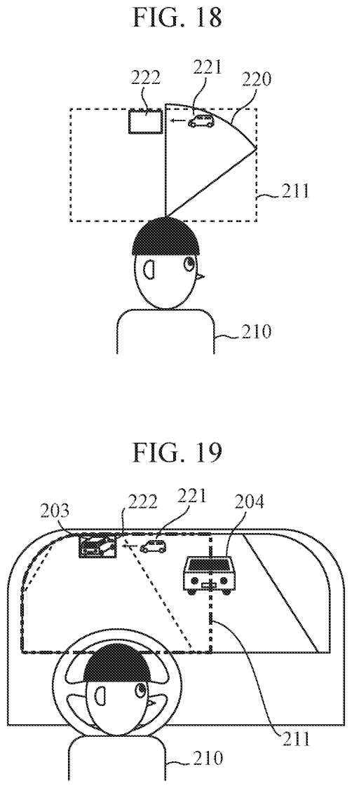

In step ST511, the display information generating unit 108a selects an object to notify the driver 210 of the presence of the different vehicle 203 and an object to be superimposed and displayed on the actual different vehicle 203 that is in sight of the driver 210 through the front window of the host vehicle 200, out of objects registered in an object storing unit 109. Here, an example of the objects 221 and 222 in Embodiment 2 is shown in FIG. 17. FIG. 18 is a view showing an example of the display information generated in the situation shown in FIG. 14. In the situation shown in FIG. 14, the different vehicle 203 is inside the HUD display area 211. The display information generating unit 108a disposes the object 221 to notify the driver 210 of the presence of the different vehicle 203 in the effective field of view 220. The display information generating unit 108a disposes the object 222 at a position in the HUD display area 211, the position coinciding with the actual different vehicle 203 that is insight of the driver 210 through the front window of the host vehicle 200. Then, the display information generating unit 108a generates display information including the contents and the positions of the objects 221 and 222.

Although in the example of FIG. 18 the object that is a vehicle icon is selected because the type of the target is vehicle, an object that is a pedestrian icon is selected when the type of the target is pedestrian.

FIG. 19 is a view showing a state in which the object 221 to provide a notification of the presence of the different vehicle 203 and the object 222 coinciding with the actual different vehicle 203 are superimposed on a front view that is in sight of the driver 210 of the host vehicle 200 in the situation shown in FIG. 14. Because there is a high possibility that the driver 210 views a right-hand side toward which the vehicle is to head, there is a high possibility that the driver does not notice the different vehicle 203 that is making a lane change to a left-hand lane. In this situation, because the object 221 is displayed in the effective field of view 220 of the driver 210, the driver 210 can surely recognize the object 221 and thereby recognize the presence of the different vehicle 203. In addition, because the object 222 as a marker is superimposed on the actual different vehicle 203, the driver 210 can more precisely recognize the presence of the different vehicle 203 emphasized by the object 222.

In step ST512, the display information generating unit 108a selects the object 221 to notify the driver 210 of the presence of the different vehicle 203 out of the objects registered in the object storing unit 109 and disposes the object in the effective field of view 220, just as instep ST506 in FIG. 8 of Embodiment 1. Then, the display information generating unit 108a generates display information including the content and the position of the object 221.

As mentioned above, the display information generating unit 108a of Embodiment 2 changes the display mode of information about a target approaching from a side opposite to the traveling direction in which the host vehicle is to head in accordance with whether the target is present inside or outside the display area of the HUD 114. With this configuration, the display device 100a can more surely notify the driver of the presence of the target that is unlikely to be noticed by the driver.

Further, when the target approaching from the side opposite to the traveling direction in which the host vehicle is to head is present inside the display area of the HUD 114, the display information generating unit 108a of Embodiment 2 superimposes the information about the target on the target that is in sight of the driver through the HUD 114. With this configuration, the display device 100a can perform superimposed display of a marker directly on the target that is unlikely to be noticed by the driver.

### Embodiment 3

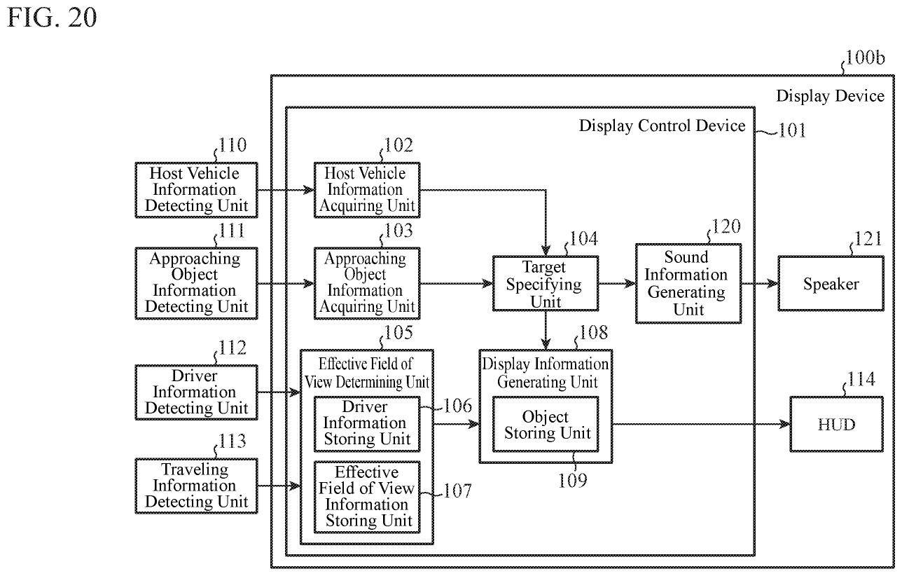

FIG. 20 is a block diagram showing an example of the configuration of a display device 100b according to Embodiment 3. The display device 100b according to Embodiment 3 has a configuration in which a sound information generating unit 120 and a speaker 121 are added to the display device 100 of Embodiment 1 shown in FIG. 1. In FIG. 20, components which are the same as or equivalent to those shown in FIG. 1 are denoted by the same reference signs, and an explanation of the components will be omitted hereinafter.

When a host vehicle makes a course change, the sound information generating unit 120 of Embodiment 3 generates sound information for outputting a sound indicating information about a target specified by a target specifying unit 104 and outputs the sound information to the speaker 121. For example, the sound information may include a voice having content, such as the position or the type of the target, and the number of targets, or a sound having no particular meaning.

The speaker 121 acquires the sound information from the sound information generating unit 120 and outputs a sound indicating the sound information.

Next, an example of the operation of the display device 100b will be explained.

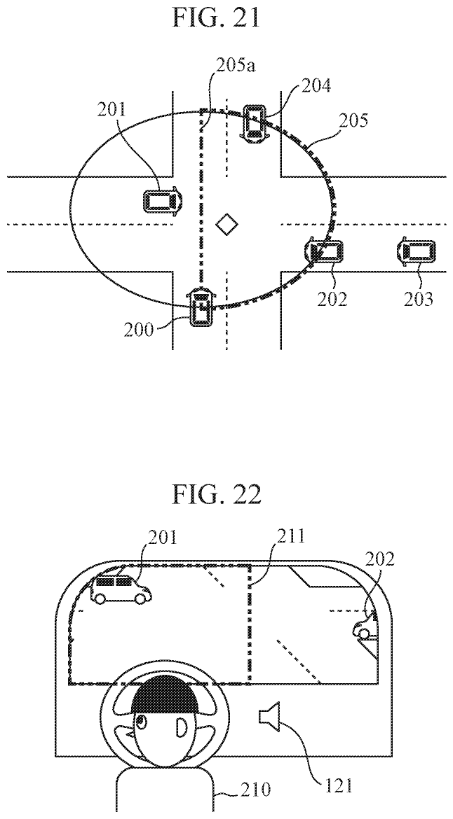

Hereinafter, the operation of the display device 100b will be explained using, as an example, a case in which the host vehicle makes a left-hand turn at an intersection. FIG. 21 is a bird's-eye view showing an example of a situation in which the host vehicle 200 makes a left-hand turn after signaling a course change to the left in Embodiment 3. In the example shown in FIG. 21, a different vehicle 201 is present on a left-hand side of the road where the host vehicle 200 is to make a left-hand turn, different vehicles 202 and 203 are present on a right-hand side of the road, and a different vehicle 204 is present in an opposite lane of the road on which the host vehicle 200 has traveled straight ahead.

FIG. 22 is a view showing a front view that is in sight of the driver 210 of the host vehicle 200 in the situation shown in FIG. 21. In the example shown in FIG. 22, the driver 210's side portion of the front window of the host vehicle 200 is an HUD display area 211 that is the display area of an HUD 114. The driver 210 can view the different vehicles 201 and 202 through the front window. Further, the speaker 121 is mounted in the vicinity of the driver 210 of the host vehicle 200.

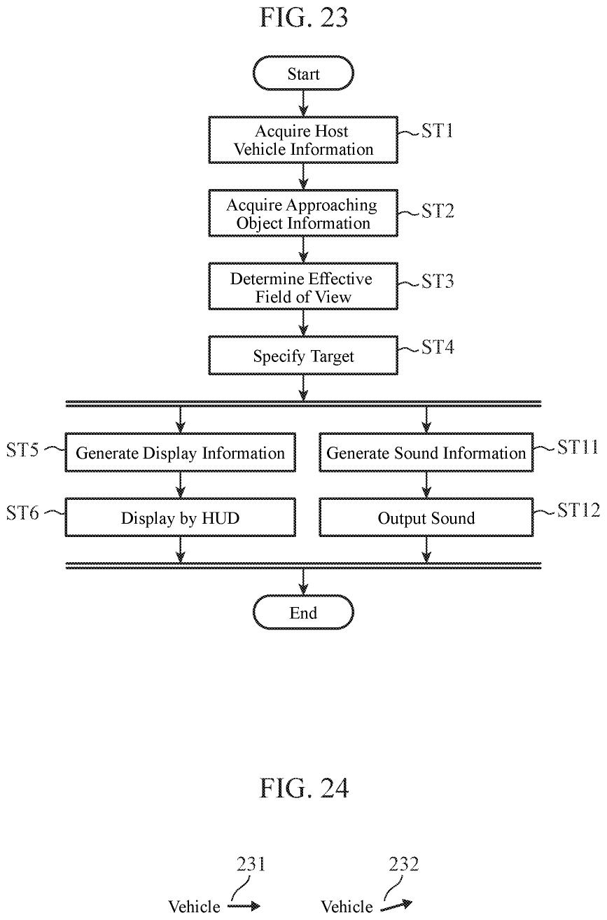

FIG. 23 is a flowchart showing an example of the operation of the display device 100b according to Embodiment 3. The display device 100b repeats the operation shown in the flowchart of FIG. 23. Steps ST1 to ST6 of FIG. 23 show the same processes as those of steps ST1 to ST6 of FIG. 5. Hereinafter, an explanation will be made focusing on the difference between the operation of the display device 100 of Embodiment 1 and that of the display device 100b of Embodiment 3.

In step ST2, an approaching object information acquiring unit 103 detects the different vehicles 201, 202, and 204 approaching the host vehicle 200 in a predetermined approaching object detection region 205 on the basis of approaching object detection information acquired from an approaching object information detecting unit 111. Then, the approaching object information acquiring unit 103 outputs approaching object information indicating that the approaching objects approaching the host vehicle 200 in the approaching object detection region 205 are the different vehicle 201 on the left-hand side of the host vehicle 200, and the different vehicles 202 and 204 on the right-hand side of the host vehicle to the target specifying unit 104.

In step ST3, an effective field of view determining unit 105 determines the position and the effective field of view of the driver 210 on the basis of driver information acquired from a driver information detecting unit 112 and traveling information acquired from a traveling information detecting unit 113, and outputs driver position information and information indicating the effective field of view to a display information generating unit 108. In the example of FIG. 21, the effective field of view determining unit 105 specifies that the driver 210 in a younger age group is traveling a road having a low congestion level, and determines that the effective field of view is 18 degrees by referring to effective field of view information registered in an effective field of view information storing unit 107. The effective field of view determining unit 105 outputs information indicating the determined effective field of view of the driver 210 to the display information generating unit 108.

In step ST4, the target specifying unit 104 specifies that the different vehicles 202 and 204 present in a side 205a opposite to a traveling direction of the host vehicle 200 are targets on the basis of information acquired from a host vehicle information acquiring unit 102 and indicating the traveling direction of the host vehicle 200, and the approaching object information about the different vehicles 201, 202, and 204 acquired from the approaching object information acquiring unit 103. The target specifying unit 104 outputs target information indicating the specified different vehicles 202 and 204 to the display information generating unit 108 and the sound information generating unit 120.

In step ST5, the display information generating unit 108 generates display information on the basis of the information indicating the traveling direction and the target information which are acquired from the target specifying unit 104, and the driver position information and the information indicating the effective field of view which are acquired from the effective field of view determining unit 105, and outputs the display information to the HUD 114.

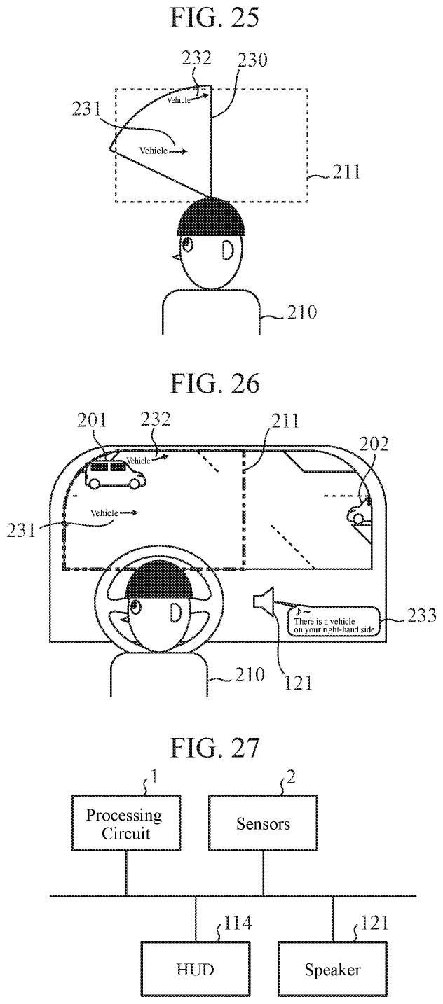

FIG. 24 is a view showing an example of objects 231 and 232 in Embodiment 3. FIG. 25 is a view showing an example of the display information generated in the situation shown in FIG. 21. The display information generating unit 108 disposes the object 231 to notify the driver 210 of the presence of the different vehicle 202 in the effective field of view 230 of the driver 210. The display information generating unit 108 also disposes the object 232 to notify the driver 210 of the presence of the different vehicle 204 in the effective field of view 230 of the driver 210. Then, the display information generating unit 108 generates display information including the contents and the positions of the objects 231 and 232.

FIG. 26 shows a state in which the objects 231 and 232 providing a notification of the presence of the different vehicles 202 and 204 are superimposed on a front view that is in sight of the driver 210 of the host vehicle 200 in the situation shown in FIG. 21. Because there is a high possibility that the driver 210 views a left-hand side toward which the vehicle is to head, there is a high possibility that the driver does not notice the different vehicles 202 and 204 approaching from a right-hand side. In this situation, because the objects 231 and 232 are displayed in the effective field of view 230 of the driver 210, the driver 210 can surely recognize the objects 231 and 232 and thereby recognize the presence of the different vehicles 202 and 204.

In step ST11, the sound information generating unit 120 generates sound information for a voice of “There is a vehicle on your right-hand side” or the like on the basis of the target information acquired from the target specifying unit 104. The sound information generating unit 120 outputs the generated sound information to the speaker 121. Just as in the case in which the display information generating unit 108 generates display information when acquiring the target information from the target specifying unit 104, the sound information generating unit 120 also generates sound information when acquiring the target information from the target specifying unit 104.

In step ST12, the speaker 121 outputs a sound indicating the sound information acquired from the sound information generating unit 120. In the example of FIG. 26, the sound information generating unit 120 causes a voice 233 of “There is a vehicle on your right-hand side” or the like that provides a notification of the presence of the different vehicle 202 to be outputted from the speaker 121. The sound information generating unit 120 causes a voice of “There is a vehicle ahead of you on your right-hand side” or the like that provides a notification of the presence of the different vehicle 204 to be outputted from the speaker 121 after the voice 233 of “There is a vehicle on your right-hand side” or the like. The sound information generating unit 120 may cause a voice of “There are vehicles on your right-hand side and ahead of you on your right-hand side” or the like that provides a notification of the presence of the different vehicles 202 and 204 to be outputted from the speaker 121. As an alternative, the sound information generating unit 120 may cause a notifying sound providing a notification of the presence of the targets to be outputted from the speaker 121.

Although in the example of FIG. 26 sound information for a voice of “There is a vehicle on your right-hand side” or the like is generated because the type of a target is vehicle, sound information for a voice of “A pedestrian is on your right-hand side” or the like is generated when the type of a target is pedestrian.

As mentioned above, the display device 100b according to Embodiment 3 includes the sound information generating unit 120 that generates sound information for outputting a sound indicating information about a target specified by the target specifying unit 104 when the vehicle makes a course change. With this configuration, the display device 100b can more surely notify, with display and sound, the driver of the presence of the target that is unlikely to be noticed by the driver.

Although the display device 100b of Embodiment 3 has a configuration in which the sound information generating unit 120 is combined with the display device 100 of Embodiment 1, the display device 100b may have a configuration in which the sound information generating unit 120 is combined with the display device 100a of Embodiment 2.

Further, although in each embodiment the effective field of view determining unit 105 determines the effective field of view on the basis of both the driving characteristic that is an internal factor and the traveling environment that is an external factor, the effective field of view determining unit 105 may determine the effective field of view on the basis of either the internal factor or the external factor. In that case, either the effective field of view information in which a correspondence between the internal factor and the effective field of view is defined or the effective field of view information in which a correspondence between the external factor and the effective field of view is defined is registered in the effective field of view information storing unit 107.

When there are multiple pieces of effective field of view information, the effective field of view determining unit 105 may select effective field of view information having a narrower effective field of view. For example, when the driver is a beginner driver and belongs to a younger age group, the effective field of view determining unit 105 gives a higher priority to a beginner driver having a relatively narrow effective field of view. Further, for example, when the traveling road is a road having a high congestion level and the vehicle speed is 40 km/h, the effective field of view determining unit 105 gives a higher priority to a road having a high congestion level and having a relatively narrow effective field of view.

Further, the internal and external factors are not limited to those illustrated in FIG. 2, and may be other factors.

Further, the values and the initial value of the effective field of view are not limited to those illustrated in FIG. 2, and may be other values.

Further, sensors that constitute the host vehicle information detecting unit 110, the approaching object information detecting unit 111, the driver information detecting unit 112, and the traveling information detecting unit 113 are not limited to the above-mentioned ones, and may be other sensors.

Further, in each embodiment, the objects displayed by the HUD 114 are not limited to those illustrated in FIGS. 10, 17, and so on, and may be other graphics or the likes.

Further, although in each embodiment the display control device 101 causes the HUD 114 to display information about a target when a signal of a course change is provided, the display control device 101 may, after a signal of a course change is provided, continue updating information about a target to be displayed by the HUD 114 on the basis of a positional relationship between the host vehicle and approaching objects, the positional relationship varying from moment to moment, until the course change is completed.

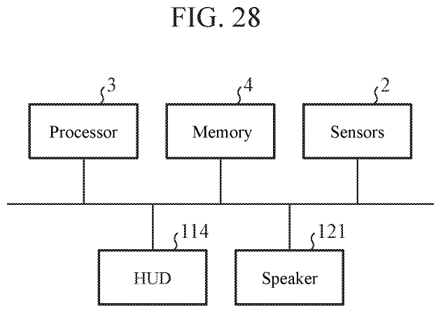

Finally, examples of the hardware configuration of each of the display devices 100, 100a, and 100b according to the embodiments will be explained. FIGS. 27 and 28 are diagrams showing the examples of the hardware configuration of each of the display devices 100, 100a, and 100b according to the embodiments. The host vehicle information detecting unit 110, the approaching object information detecting unit 111, the driver information detecting unit 112, and the traveling information detecting unit 113 in each of the display devices 100, 100a, and 100b are sensors 2. Each of the functions of the host vehicle information acquiring unit 102, the approaching object information acquiring unit 103, the target specifying unit 104, the effective field of view determining unit 105, the display information generating unit 108 or 108a, and the sound information generating unit 120 in each of the display devices 100, 100a, and 100b is implemented by a processing circuit. More specifically, each of the display devices 100, 100a, and 100b includes a processing circuit for implementing each of the above-mentioned functions. The processing circuit may be a processing circuit 1 as hardware for exclusive use or a processor 3 that executes a program stored in a memory 4. The driver information storing unit 106, the effective field of view information storing unit 107, and the object storing unit 109 in each of the display devices 100, 100a, and 100b are implemented by the memory 4.

In the case in which the processing circuit is hardware for exclusive use as shown in FIG. 27, the processing circuit 1 is, for example, a single circuit, a composite circuit, a programmable processor, a parallel programmable processor, an application specific integrated circuit (ASIC), a field programmable gate array (FPGA), or a combination of these circuits. The functions of the host vehicle information acquiring unit 102, the approaching object information acquiring unit 103, the target specifying unit 104, the effective field of view determining unit 105, the display information generating unit 108 or 108a, and the sound information generating unit 120 maybe implemented by multiple processing circuits 1, or the functions of the units may be implemented collectively by a single processing circuit 1.

In the case in which the processing circuit is the processor 3 as shown in FIG. 28, each of the functions of the host vehicle information acquiring unit 102, the approaching object information acquiring unit 103, the target specifying unit 104, the effective field of view determining unit 105, the display information generating unit 108 or 108a, and the sound information generating unit 120 is implemented by software, firmware, or a combination of software and firmware. The software or the firmware is described as a program and the program is stored in the memory 4. The processor 3 implements the function of each of the units by reading and executing a program stored in the memory 4. More specifically, each of the display devices 100, 100a, and 100b includes the memory 4 for storing a program by which the steps shown in the flowcharts of FIG. 5 and so on are performed as a result when the program is executed by the processor 3. Further, it can be said that this program causes a computer to perform procedures or methods that the host vehicle information acquiring unit 102, the approaching object information acquiring unit 103, the target specifying unit 104, the effective field of view determining unit 105, the display information generating unit 108 or 108a, and the sound information generating unit 120 use.

Here, the processor 3 is a central processing unit (CPU), a processing device, an arithmetic device, a microprocessor, or the like.

The memory 4 may be a non-volatile or volatile semiconductor memory, such as a random access memory (RAM), a read only memory (ROM), an erasable programmable ROM (EPROM), and a flash memory, may be a magnetic disc, such as a hard disc and a flexible disc, or maybe an optical disc, such as a compact disc (CD) and a digital versatile disc (DVD).

A part of the functions of the host vehicle information acquiring unit 102, the approaching object information acquiring unit 103, the target specifying unit 104, the effective field of view determining unit 105, the display information generating unit 108 or 108a, and the sound information generating unit 120 maybe implemented by hardware for exclusive use, and another part of the functions may be implemented by software or firmware. As mentioned above, the processing circuit in each of the display devices 100, 100a, and 100b can implement each of the above-mentioned functions by using hardware, software, firmware, or a combination of hardware, software, and firmware.

Any combination of two or more of the above-mentioned embodiments can be made, various changes can be made in any component according to any one of the above-mentioned embodiments, or any component according to any one of the above-mentioned embodiments can be omitted within the scope of the present disclosure.

### INDUSTRIAL APPLICABILITY

Because the display device according to the present disclosure notifies the driver of a target approaching the host vehicle outside the effective field of view of the driver, the display device according to the present disclosure is suitable for display devices used for driving supporting devices that support driving, and the likes.

### REFERENCE SIGNS LIST

1 processing circuit, 2 sensors, 3 processor, 4 memory, 100, 100a, 100b display device, 101 display control device, 102 host vehicle information acquiring unit, 103 approaching object information acquiring unit, 104 target specifying unit, 105 effective field of view determining unit, 106 driver information storing unit, 107 effective field of view information storing unit, 108, 108a display information generating unit, 109 object storing unit, 110 host vehicle information detecting unit, 111 approaching object information detecting unit, 112 driver information detecting unit, 113 traveling information detecting unit, 114 HUD, 120 sound information generating unit, 121 speaker, 200 host vehicle, 201 to 204 different vehicle, 205 approaching object detection region, 205a side opposite to traveling direction, 210 driver, 211 HUD display area, 212, 220, 230 effective field of view, 213, 221, 222, 231, 232 object, and 233 voice.

1. A display control device for causing a head up display to display information which is to be provided for a driver of a vehicle, the display control device comprising:
processing circuitry
acquire host vehicle information indicating both a signal of a course change that the vehicle is to make, and a traveling direction in which the vehicle is to head because of the course change;
acquire approaching object information indicating one or more approaching objects approaching the vehicle in a predetermined region in surroundings of the vehicle;
determine an effective field of view of the driver of the vehicle;
specify, out of the approaching objects approaching the vehicle, an approaching object approaching from a side opposite to the traveling direction in which the vehicle is to head on a basis of the host vehicle information and the approaching object information, and to set the specified approaching object as a target; and
generate, when the vehicle makes the course change, on a basis of the host vehicle information, display information for displaying information about the specified target in the determined effective field of view of the driver.

2. The display control device according to claim 1, wherein the processing circuitry changes the effective field of view of the driver on a basis of at least one of a driving characteristic of the driver and a traveling environment of the vehicle.

3. The display control device according to claim 1, wherein the host vehicle information is at least one of information indicating a lighting state of a direction indicator of the vehicle, information indicating a steering angle of the vehicle, and information indicating a scheduled traveling route of the vehicle.

4. The display control device according to claim 1, wherein the course change is a right-hand turn, a left-hand turn, a lane change to a right-hand lane, or a lane change to a left-hand lane of the vehicle.

5. The display control device according to claim 1, wherein the processing circuitry changes a display mode of the information about the target in accordance with whether the target approaching from the side opposite to the traveling direction in which the vehicle is to head is present inside or outside a display area of the head up display.

6. The display control device according to claim 5, wherein when the target approaching from the side opposite to the traveling direction in which the vehicle is to head is present inside the display area of the head up display, the processing circuitry superimposes the information about the target on the target that is in sight of the driver through the head up display.

7. The display control device according to claim 1, wherein the processing circuitry generates, when the vehicle makes the course change, sound information for outputting a sound indicating the information about the target specified.

8. A display device comprising:
the display control device according to claim 1; and
the head up display to display the display information generated by the processing circuitry.

9. A display control method of causing a head up display to display information which is to be provided for a driver of a vehicle, the display control method comprising:
acquiring host vehicle information indicating both a signal of a course change that the vehicle is to make, and a traveling direction in which the vehicle is to head because of the course change;
acquiring approaching object information indicating one or more approaching objects approaching the vehicle in a predetermined region in surroundings of the vehicle;
determining an effective field of view of the driver of the vehicle;
specifying, out of the approaching objects approaching the vehicle, an approaching object approaching from a side opposite to the traveling direction in which the vehicle is to head on a basis of the host vehicle information and the approaching object information, and setting the specified approaching object as a target; and
when the vehicle makes the course change, generating, on a basis of the host vehicle information, display information for displaying information about the specified target in the determined effective field of view of the driver.
